(19) United States
(12) Patent Application Publication
(10) Pub. No.: US 2026/0113319 A1
(43) Pub. Date: Apr. 23, 2026

(54) JUST IN TIME AUTHORIZATION WITH A COMBINATION OF SIGNALS

(71) Applicant: Meta Platforms Technologies, LLC, Menlo Park, CA (US)

(72) Inventor: Aleksandr Krasnov, Langley (CA)

(73) Assignee: Meta Platforms Technologies, LLC, Menlo Park, CA (US)

(21) Appl. No.: 19/364,198

(22) Filed: Oct. 21, 2025

Related U.S. Application Data
(60) Provisional application No. 63/710,461, filed on Oct. 22, 2024.

(51) Int. Cl. H04L 9/40

(52) U.S. Cl. CPC H04L 63/0876; H04L 2463/082

(57) ABSTRACT

A method comprising receiving, by a computing device, a set of signals to validate a session for a user, and using a model to calculate an authenticity score, based on the set of signals received, to validate an authenticity of the user. Disclosed are systems and related methods.

### CROSS-REFERENCE TO RELATED APPLICATION

This application claims the benefit of U.S. Application No. 63/710,461 filed Oct. 22, 2024, the entirety of which is hereby incorporated by reference.

### BACKGROUND

User account security may be improved via various methods, such as multifactor authentication. However, such methods may be problematic at times, such as when a user does not have access to another device or code. Accordingly, just in time authorization with a combination of signals may be desired.

### BRIEF DESCRIPTION OF DRAWINGS

The accompanying appendices illustrate a number of exemplary embodiments and are a part of the specification. Together with the following description, these appendices demonstrate and explain various principles of the present disclosure.

FIG. 1 is an illustration of a flowchart detailing a method of signature collection, reporting, and verification for a cross-app attestation signal, according to some embodiments.

FIG. 2 is an illustration of a diagram detailing a criteria used to calculate a fake-hacked score, according to various embodiments.

FIG. 3 is an illustration of a flowchart detailing a set of received signals for an identity verification process of a user, according to particular embodiments.

FIG. 4 is an illustration of a model for calculating a fake account index (FAI) score using specifics about a user's account, according to some embodiments.

Throughout the appendices, identical reference characters and descriptions indicate similar, but not necessarily identical, elements. While the exemplary embodiments described herein are susceptible to various modifications and alternative forms, specific embodiments have been shown by way of example in the appendices and will be described in detail herein. However, the exemplary embodiments described herein are not intended to be limited to the particular forms disclosed. Rather, the present disclosure covers all modifications, equivalents, and alternatives falling within this disclosure.

### DETAILED DESCRIPTION OF EXEMPLARY EMBODIMENTS

With the increase of attempted identity scams on Instagram, WhatsApp, Messenger, Threads, and Meta, users have been trying to protect their accounts using multifactor authentication, passwordless authentication, open authorization, and/or biometrics. However, these authentication measures often fail to provide a holistic approach for properly authenticating and authorizing users to gain access to their accounts.

The present disclosure is generally directed to a method that uses a combination of received signals to validate a user's identity, based on a calculated authenticity score determined from a model for weighting the combined signals. For example, when authorization is initially suggested by a device, a user may provide a set of signals such as a session ID, multifactor authentication codes, biometrics, a just-in-time snapshot of a person and its comparison of the snapshot to the Instagram profile, and characterization of a person's writing style in Messenger, WhatsApp, and Threads. In this example, whenever a user logs into their Instagram account, a decision may be made in real-time regarding whether to validate the authenticity of a user's identity from the calculated authenticity score. Furthermore, the authenticity score calculated from the combination of received signals may be more precise in identifying if the account has been compromised or not.

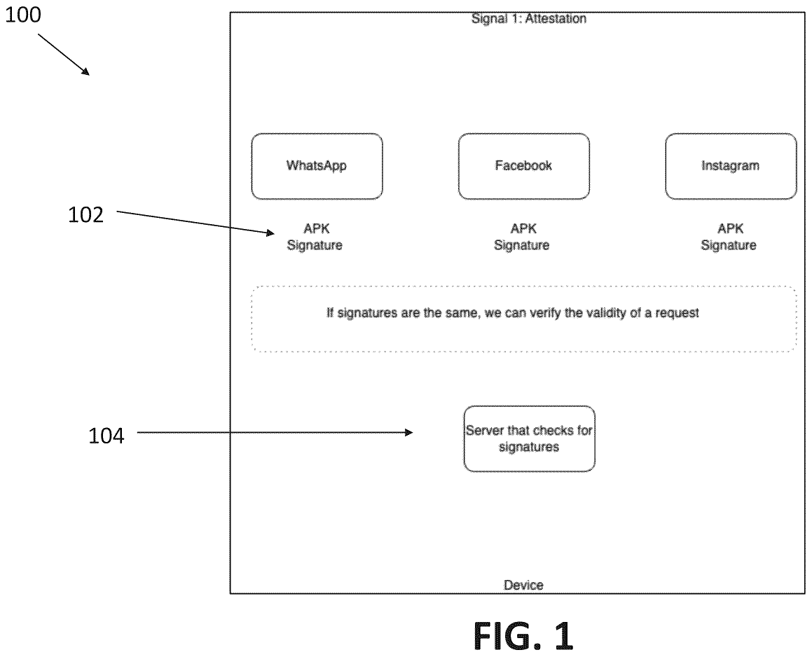

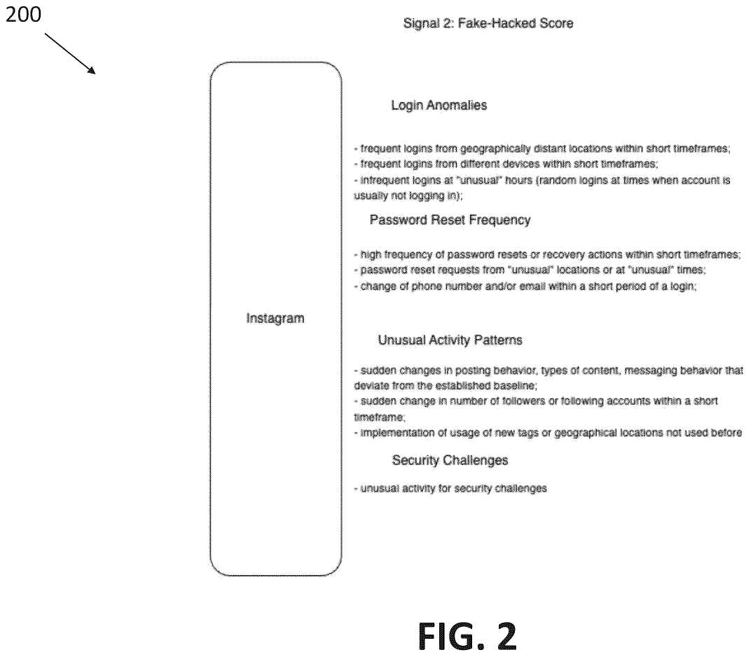

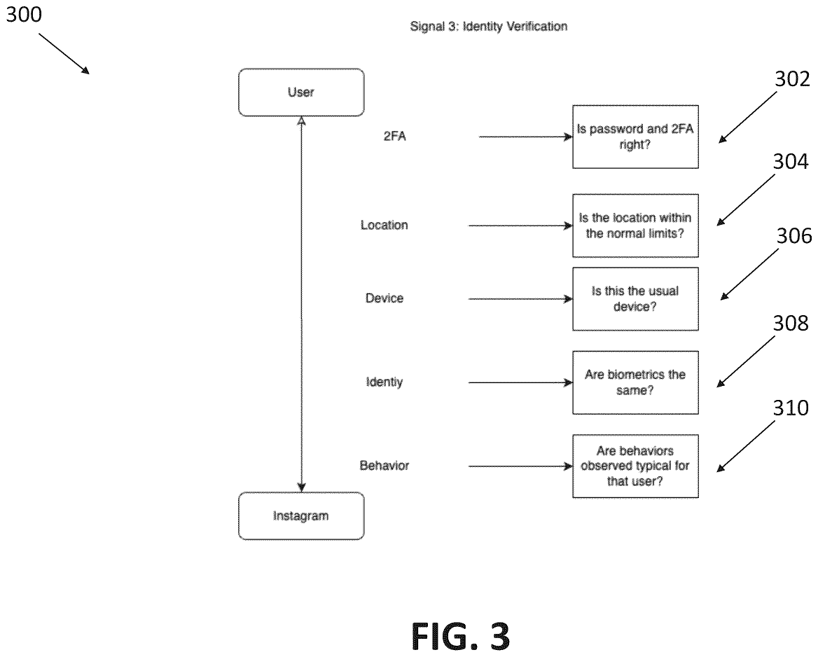

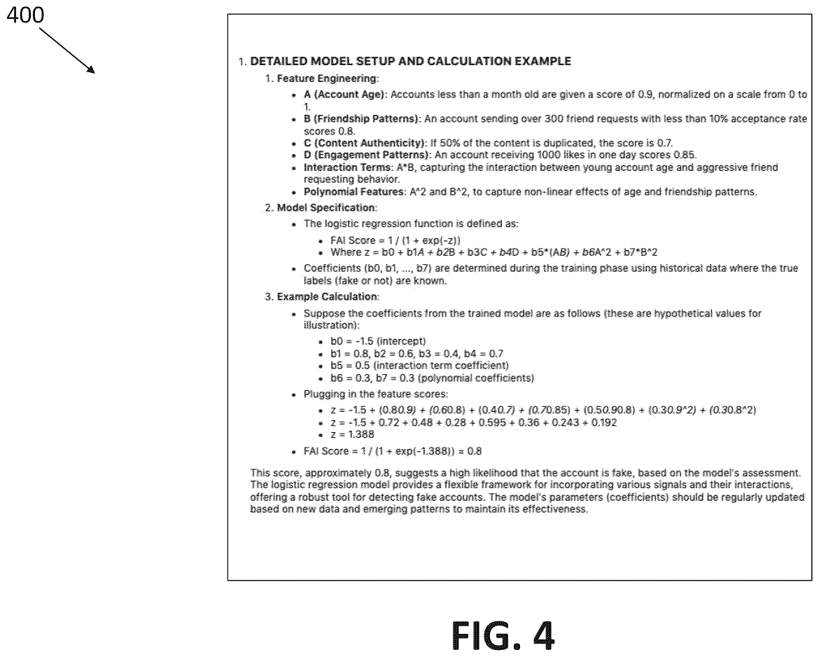

The following will provide, with reference to FIGS. 1-4, detailed descriptions of devices and related methods associated for a user's authorization using a combination of signals. The discussion associated with FIG. 1 includes a flowchart detailing a method of signature collection, reporting, and verification for a cross-app attestation signal. The discussion associated with FIG. 2 includes a diagram of criteria used to calculate a fake-hacked score. The discussion associated with FIG. 3 includes a flowchart detailing a set of received signals for an identity verification process of a user. The discussion associated with FIG. 4 includes a model for calculating a fake account index (FAI) score using specifics about a user's account.

FIG. 1 illustrates an example flowchart 100 detailing a method of signature collection, reporting, and verification for a cross-app attestation signal. Flowchart 100 includes using Android application package (APK) signatures from other applications on the same device to verify an application's validity. For example, each application on a device (e.g., Facebook, WhatsApp, Instagram, etc.) may report APK signatures 102 of other installed apps. Correspondingly, the signatures are then cross-verified against a database 104 of known signatures. In this manner, it may be possible to ascertain whether the applications were being tampered with by comparing the APK signatures 102 reported from the other apps on the device. Furthermore, flowchart 100 further illustrates a robust method of attestation, which would require a hacker to tamper through all apps on the device to bypass this security measure.

FIG. 2 illustrates an example diagram 200 of criteria used to calculate a fake-hacked score. Diagram 200 illustrates criteria used to assess the likelihood that an account may be compromised. In this example, the criteria in diagram 200 may be useful in environments where identity integrity is crucial, such as during the merging of profiles or determining the authenticity of public figure pages on social media platforms. Furthermore, algorithms may analyze account behavior such as unusual activity patterns, login anomalies, passport reset frequency, and/or security challenges to assign a fake hacked score. Correspondingly, fake, or hacked accounts may be identified, preventing fraudulent activities.

FIG. 3 is an illustration of an example flowchart 300 detailing a set of received signals for an identity verification process of a user. For example, flowchart 300 may illustrate a method for receiving a set of signals by a computing device to validate a session for a user. First signal 302 may require users to provide two forms of identification, such as with a password and verification from a mobile device. Second signal 304 may check a geographical location of the user to ensure the expected region is matched. Third signal 306 may perform a device check confirming unique identifiers such as an IP address against a pre-established list of trusted devices on the network. Fourth signal 308 may verify the identity of a user through official documents or biometric data. For example, the biometric data may include a snapshot of a user that is used in comparison to the user's Instagram profile to validate the authenticity of the user. Fifth signal 310 may observe behaviors of the user to analyze if the behaviors are typical of the user. For example, a linguistic model may be applied to confirm that a style of writing in the apps is similar to the user's typical style of writing. In this manner, a model may be developed to calculate an authenticity score, based on the set of signals received, as illustrated in FIG. 3, to validate an authenticity of the user.

FIG. 4 is an illustration of an example model 400 for calculating an FAI score using specifics about a user's account. For example, a set of signals such as the age of the user's account, friendship patterns in the account, content authenticity, engagement patterns, and/or polynomial features to capture non-linear effects of age and friendship patterns, may be weighted in model 400 to determine an FAI score. As used herein, “FAI score” may generally refer to an example of an authenticity score for determining a likelihood of a fake account. In this example, model 400 may calculate an authenticity score, based on the set of signals received, for detecting fake accounts. As illustrated in FIG. 4, a low FAI score determined by model 400 may suggest a likelihood of a fake account.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. A method comprising:
receiving, by a computing device, a set of signals to validate a session for a user; and
using a model to calculate an authenticity score, based on the set of signals received, to validate an authenticity of the user.
